(19) United States
(12) Patent Application Publication
(10) Pub. No.: US 2015/0050379 A1
(43) Pub. Date: Feb. 19, 2015

(54) MOULD ASSEMBLY AND APPARATUS FOR PROVIDING ONE OR TWO SHOES SIMULTANEOUSLY

(71) Applicant: ECCO SKO A/S, Bredebro (DK)

(72) Inventors: Nicholas Charles Ginns, Nontaburi Bangkok (TH); Arkom Kaewprasit, Muang Samutprakan (TH)

(21) Appl. No.: 14/387,944

(22) PCT Filed: Mar. 15, 2013
(86) PCT No.: PCT/DK2013/050073

§ 371 Date: Sep. 25, 2014

(30) Foreign Application Priority Data
Mar. 26, 2012 (PA) PA 2012 70146

(51) Int. Cl. B29C 45/27; B29C 45/26; B29C 45/73; B29C 45/14

(52) U.S. Cl. CPC B29C 45/2701; B29C 45/14336; B29C 45/26; B29C 45/73; B29C 2045/2683; B29L 2031/504
USPC 425/500

(57) ABSTRACT

A mould assembly for moulding two soles for two shoes 1 simultaneously and comprising an upper mould part and a lower mould part 16. The upper mould part comprises a first side frame 8 and a second side frame 9 and between them a middle frame 10. The side frames are adapted to be laterally movable in relation to the middle frame 10 and the lower mould part 16 The mould assembly comprises two cavities 15′,15″ for forming the soles. The mould assembly comprises force means 37 adapted to move the two side frames 8, 9 in a straight and linear movement towards the middle frame 10. The lower mould part 16 is adapted to being vertically movable in relation to the upper mould part.

The invention relates to a mould assembly and an apparatus for moulding shoes.

DE 4,217,465 discloses an apparatus for simultaneously forming two soles on two lasts. The apparatus comprises two side frames being moved simultaneously with the movement of the two lasts. The movement is a pivotable movement and the lasts are mounted on pivoting arms. The side frames are connected to the pivoting arms and are also moved in a pivoting manner away from the mould cavity after the mould injection has taken place. The pivoting movement of the side frames and the lasts suffers from the disadvantage caused by the lasts and the side frames being wedged to the support surface. The system is also quite complicated and requires precision of the components and the construction as such in order to work.

As the side frames of the mould are related to the movement of the lasts it is complicated and time-consuming to exchange a mould with another mould.

Due to the last arrangement and the connection to the mould, the apparatus as such is not suitable for manufacturing just one shoe at a time. The apparatus is therefore quite expensive as it is only designed for manufacturing two shoes at a time

One aspect of the present invention is to provide a mould assembly for providing two shoes simultaneously and to provide an apparatus suitable for handling a mould assembly notwithstanding that the mould is a one shoe mould or a two shoe mould assembly according to the invention.

A further aspect is to solve at least one of the problems mentioned in the prior art or at least providing a useful alternative.

According to the first aspect of the invention, a mould assembly is provided for moulding two soles for two shoes simultaneously such as midsoles and outsoles, said mould assembly comprising an upper mould part and a lower mould part, said upper mould part comprising three parts, a first side frame and a second side frame and between them a middle frame, said first and second side frame adapted to be laterally movable in relation to the middle frame and in relation to the lower mould part; said mould assembly comprising two cavities for forming the soles, said mould assembly comprising force means adapted to move the two side frames in a straight and linear movement towards the middle frame, said lower mould part is adapted to being vertically movable in relation to the upper mould part by moving means.

The side frames move in a linear and straight movement. Thereby, it is avoided that the side frames are wedged. The side frames move with the same velocity during the entire movement and with the same pattern of movement. The force for moving the frames towards each other and apart from each other is constant.

Further, as the means for moving lasts down in the cavities provided by the mould assembly is not directly connected to the means for moving the side frames, the lasts and the side frames move independently. It is easy to adjust an expedient movement of the mould assembly. Finally, as the side frames are moving linearly and straight, the force for moving the side frames will always have the same direction and the same impact on the frames. The force is parallel with the direction of movement of the frames.

The injection chamber is defined as the open space delimited by the top of the contour plates (i.e. the top of the lower mould), the two side frames and the middle frame, and they abut an upper placed on the last. More precisely, the injection chamber is the open space created when the piston moving the lower mould part has been raised, the side frames have enclosed the middle frame, and the lower mould part and the lasted uppers have been lowered into a position ready for injection. Inside this space, the injection material is injected and intended for flow. By this arrangement, two shoes are produced simultaneously, and the time for producing the shoes is nearly the same as the time used for producing one shoe using conventional one-shoe-manufacturing technology. The invention is thus cost efficient and saves time.

The mould assembly is used in an apparatus according to the invention in the following way: An upper is lasted on each last, and two outsoles are placed in the cavities. The two lasted uppers are lowered into the mould. The two side frames of the mould are moved horizontally towards each other and press against the upper. By this movement, the upper of each last abuts the side frames and the middle frame. Thereafter, a piston moving the lower mould part is elevated and seals the mould. An injection comprising the composition is made through one or two sprue channels, and the melt follows the sprue channel(s) and flows further into the two side channels and into the two spaces created and delimited by the lower part of the lasts, the side frames, the middle frame, and the surface of the lower mould part. If one sprue channel is present, it will split up into two side channels. When two sprue channels are present, one sprue channel continues into the first side channel and the other sprue channel continues into the second side channel. The lower mould part may move slightly upwards in order to control the final shape of the sole. After the injected composition has cured, the two side frames are moved horizontally, straight and away from the lasted uppers, said uppers now having a midsole, and the outsole being bonded to the uppers. The two lasts are moved horizontally away from each other in order to release them from undercuts from the middle frame. Thereafter, the lasts are raised in vertical direction to their original position.

Shoes are understood as footwear, boots or any other outer covering for the human foot.

In a preferred embodiment of the invention, the middle frame is an exchangeable device adapted to be stationary and detachably connected to the lower mould part.

The arrangement could be a pater/mater-arrangement, where the middle frame comprises at least two grooves, said grooves each enclosing a rod, said rod being part of the lower mould pointing towards an inlet of the grooves. Thereby, the part can easily be exchanged.

In a further preferred embodiment of the invention, the force means comprises means such as a piston for opening and closing the upper mould part, said force means placed in relation to the first and second side frame and adapted to move the side frames linear and straight opposite each other.

This provides a uniform and steady force.

Advantageously, the force means is a pneumatic working cylinder. The force is transferred through knee-joints to the side frames moving the frames towards and away from each other. The force means also ensures that the side frames are kept in a tight position during the moulding of the soles.

In a further preferred embodiment of the invention, the lower mould part comprises two contour plates enclosed by the upper mould part, said contour plate having a contour similar to the outsole of the footwear and the contour plates being connected to the lower mould part by flexible means connecting the contour plates to the lower mould part, by said flexibility the contour plates are adapted to move relative to the lower mould part.

Thereby, the contour plates are adjustable so as to fit in relation to the upper mould part making the mould as such tight. The flexibility also makes it easier to adjust the parameters for moving the lasts and the parameters for moving the side frames.

The outsoles may be pre-manufactured and placed on the contour plates, or the outsoles may be manufactured directly in the mould by injecting melts into the mould, whereby the contour plates shape the outsoles.

In a preferred embodiment of the invention, the outsoles are provided by a separate step by injecting melt into the lower mould part, and an upper mould different from the upper mould used for producing the midsoles is lowered into the lower mould part. Thereby, the outsole is manufactured in the same apparatus as the rest of the shoe. The upper mould differs from the upper mould used for the rest of the process.

In a preferred embodiment of the invention, the outsoles are provided by a separate step outside the apparatus, said outsoles being produced in a separate machine and the preformed outsoles being placed in the lower mould part. Thereby, the outsole is provided outside the apparatus used for making the two shoes simultaneously.

In a preferred embodiment of the invention, the upper mould part comprises at least one sprue channel, the sprue channel being provided by two half cup-shaped channels placed in each of their side frames, the two cup-shaped channels forming the sprue channel when the two side frames are in the closed position abutting each other.

By using one sprue channel and splitting the channel into two side channels or using two separate sprue channels each continuing into a side channel, it is possible to ensure that the quantity and the mechanical/chemical properties of the injected material are the same for the two produced shoes produced by the method.

In a preferred embodiment of the invention, the upper mould part comprises two sprue channels, each sprue channel being provided by two channels shaped as half cup channels, said half cup channels being placed in each their side frames, the two oppositely placed cup-shaped channels forming one sprue channel when the two side frames are in the closed position abutting each other.

Thereby, two separate injectors are used; one injector injecting the composition into one sprue channel and further into one side channel and the other injector injecting the composition into the other sprue channel and further into the other side channel. Thereby, it is ensured that no back-flow of the melt takes place.

In a preferred embodiment of the invention, the composition injected in each cavity is injected at a heel part of the upper and in an area in a distance from the heel parts. Thereby, it is ensured that the material is distributed to the whole cavity which is especially important when a voluminous midsole or a large size shoe is to be produced.

In a preferred embodiment of the invention, each sprue channel(s) is/are continuing into side channels: a first side channel placed with at least one outlet at the first cavity and a second side channel placed with at least one outlet at the second cavity.

In a preferred embodiment of the invention, the mould assembly comprises two separate and vertically displaced sprue channels, one sprue channel continuing into a first side channel and the other sprue channel continuing into a second side channel and the inlets of the side channels being vertically displaced in relation to each other and each inlet being in fluid-tight connection with a sprue channel when the mould is in its closed position.

Using two sprue channels implies two injection machines, and the parameters of these machines are then to be synchronous and an equal amount of composition is led into each cavity. Using several sprue channels may be relevant when different kinds of compositions are to be injected in order to produce mid-soles with different mechanical properties in different areas.

There may be more than one outlet in each cavity. This may be necessary when large sizes of shoes are to be produced in order to ensure that an equal distribution of the melt in the cavities takes place.

In a preferred embodiment of the invention, the upper mould part comprises an insert detachably placed in a recess of the middle frame and in the area where the sprue channel continues into the side channels.

In a preferred embodiment, the upper mould part further comprises an insert detachably placed in a recess in each of the side frames and in an area where the first and the second side channels are bending towards the cavities.

In a preferred embodiment, the upper mould part further comprises two inserts, each detachably placed in a recess and each placed at the outlet of the side channels, the first insert being placed in the side frame, and the second insert being placed in the middle frame, said two inserts being aligned with each other by a key arrangement when the mould is closed.

The first insert is placed in the side frame, and the second insert is placed in the middle frame. Said two inserts are aligned with each other by a key arrangement when the mould is closed.

By using such inserts, the abrasion of the mould itself is reduced in this area as the inserts are made in a more wear-resistant material than the rest of the mould and they are exchangeable.

In a further preferred embodiment of the invention, the first side frame comprises a first slide table and a first side mould part, and the second side frame comprises a second slide table and a second side mould part, said each side mould part comprising a first surface following the contour of the abutting part of the last, said surface turning towards the middle frame and an oppositely placed second surface turning away from the middle frame, said side mould parts being adapted to be detachably connected to the slide tables by connecting means, and said second surface of the side mould parts turning towards a surface of each of the slide tables.

By this arrangement, the construction of the mould assembly is easier to produce and construct, as it provides a higher degree of freedom. Thereby, it is possible to construct the mould assembly as a tight construction and no melt is escaping the mould during the process.

In a preferred embodiment of the invention, the middle frame is heated by a first heating element integrated in or abutting the middle frame, by said heating the temperature of the middle frame reaches a suitable value for the process.

Thereby, it is avoided that the injected material is unsuitably cooled down when meeting the middle frame.

In a preferred embodiment of the invention, the lower mould part is heated by a second heating element integrated in or abutting the lower mould part.

The second heating element is constructed in such a way that the heating intensity and the heating area may differ from one shoe to another depending on the size type and material.

The invention further comprises an apparatus for manufacturing of footwear comprising a mould assembly for forming one or simultaneously two shoes, said apparatus comprising a lower mould part and a upper mould part comprising side frames, said lower mould part comprising a first cavity and a second cavity or one single cavity, said side frames comprising a first side frame and a second side frame, said side frames being placed at each side of the centre plane of the apparatus, said apparatus comprising force means for moving the side frames towards and away from each other, between a first and a second position, said apparatus further comprising at least one exchangeable last moved by means of second means, said last(s) is/are adapted to be placed in the cavity/each cavity when the side frames are in their second position, wherein the force means are adapted to position the first and the second side frame when the side frames are in the second position being the closed position of the mould, said apparatus further comprising a separate anti-push-up device comprising at least two anti-push-up cylinders, said anti-push-up cylinders being arranged in order to prevent a movement upwards of the tip of the last(s) during moulding of the shoe/sole, said cylinders being adapted to be activated such that two cylinders are moving synchronically when two shoes are formed and one cylinder is activated when one shoe is formed.

Advantageously, the cylinders are arranged in line.

The apparatus is usable for a one shoe mould assembly and for a two shoe mould assembly according to the invention. The anti-push-up device is arranged so that one or two cylinders are activated depending on whether the chosen mould assembly comprises one or two cavities. Thereby, a cost saving and easy to adjust apparatus is provided, thus making the production of shoes very flexible.

In a preferred embodiment of the invention, the apparatus comprises force means such as a piston for opening and closing the upper mould, said force means being placed at each outer side of the first and second frame such as a piston placed at each side and adapted to move said frames simultaneously and opposite each other.

Thereby, the force for opening and closing the side frames of the mould is parallel to the direction of movement of the side frames. The force means may be a pneumatically or hydraulically operated piston.

Each of the ends of the piston is connected to a knee-joint, said knee-joint being connected to the side frames. Advantageously, the force means is a pneumatic working cylinder. The force is transferred through knee-joints to the side frames moving the frames towards and away from each other. The force means also ensures that the side frames are kept in a tight position during the moulding of the soles.

In a preferred embodiment of the invention, the apparatus comprises three separate anti-push-up cylinders, said anti-push-up cylinders being arranged in order to prevent a movement upwards of the tip of the lasts during moulding of the shoe/sole, said cylinders being arranged in line and adapted to be activated such that the outer two of the cylinders are moving synchronically while the middle cylinder is stationary or is moving alone while the two outer cylinders are stationary.

Thereby, the same apparatus may be used for providing shoes notwithstanding that the mould assembly comprises a one cavity mould assembly or a two cavity mould assembly. Due to the anti-push-up device comprising three cylinders, it is very easy to adapt the apparatus from one mould cavity assembly to a two cavities mould assembly as the anti-push-up device is placed in the same position. The difference is whether it is the cylinder in the middle being activated or the two outermost cylinders being activated. This makes the apparatus easy to adjust and very flexible.

A In a preferred embodiment of the invention, the first side frame comprises a first slide table and a first side mould part, and the second side frame comprises a second slide table and a second side mould part, said each side mould part comprising a first surface following the contour of the abutting part of the last, said surface turning towards the middle of the apparatus and an oppositely placed second surface, said side mould parts being adapted to be detachably connected to the slide tables by locking means, said second surface of the side mould parts turning towards a surface of each of the slide tables.

By this arrangement, the construction of the mould assembly is easier as it provides a higher degree of freedom. Thereby, it is possible to construct the mould assembly as a tight construction and no melt is escaping the mould during the process.

In a preferred embodiment of the invention, the mould assembly further comprises an exchangeable middle frame, said middle frame being locked by means unmovable to the lower mould part and placed between the side frames, whereby two cavities are made, said apparatus further comprising two lasts; a first last and a second last, said first last adapted to be placed in the first cavity and the second last adapted to be placed in the second cavity.

This is the case when the apparatus is used for providing two shoes simultaneously.

Thereby, uniform and reproducible footwear is obtained. Further, due to the pattern of movement of the mould assembly, it is convenient that the left and right lasts move simultaneously. Further, when right and left lasts move uniformly, the time for producing a pair of shoes is minimised and optimized.

In a preferred embodiment of the invention, the middle frame is exchangeably and immovable connected to the lower mould part by means of e.g. a screw and/or an undercut.

In a preferred embodiment of the invention, the second means are adapted to move the lasts in a horizontal and vertical direction and comprising parts such as a piston, each step of movement being linear.

Using pistons is a simple way of obtaining the movement of the lasts.

In a preferred embodiment of the invention, the middle frame is adapted to be stationary and detachably connected to the lower mould part by a pater/mater-arrangement.

In a preferred embodiment of the invention, the second means comprise a second part such as a double piston moving the lasts simultaneously in a direction perpendicular to the linear vertical movements, said first last being adapted to be moved in the opposite direction of the movement of the second last.

Using a double piston is a simple way of obtaining uniform and straight movement of the two lasts opposite each other in horizontal direction. The lasts move up and down and sideways with the same velocity and distance.

In a preferred embodiment of the invention, the lower mould part comprises two contour plates enclosed by the upper mould part, said each contour plate having a contour similar to the outsole of the footwear, and the contour plates being connected to the lower mould part by flexible means connecting the contour plates to the lower mould part, the contour plates being adapted by said flexibility to move relative to the lower mould part.

In a preferred embodiment of the invention, a first heating element is placed in or abuts the middle frame.

Thereby, it is avoided that the injected material is unsuitably cooled down when meeting the middle frame.

In a preferred embodiment of the invention, a second heating element is placed or abuts the lower mould part.

The second heating element is constructed in such a way that the heating intensity and the heating area may differ from one shoe to another depending on the size type and material.

In a preferred embodiment of the invention, the apparatus further comprises an adapter, said adapter being constructed to be placed in relation to the side frames.

Thereby, different mould sizes can be used in the same apparatus as the adapter is placed if the mould is too small for the apparatus, i.e. changing the mould assembly from comprising a two cavity mould to a one cavity mould. The adapter is a piece of metal and the outer surfaces of the device are congruent to the surfaces it abuts.

The invention further comprises use of a mould assembly according to the invention in an apparatus according to the invention.

In a preferred embodiment of the invention, the composition is ethylene vinyl acetate (EVA), natural or synthetic rubber, polyurethane (PU) or thermoplastic polyurethane (TPU).

In a further preferred embodiment of the invention, the outsole is made of a hard-wearing material, such as a natural or synthetic rubber, polyurethane (PU), thermoplastic polyurethane (TPU), thermoplastic elastomer (TPE), latex or leather.

In a further preferred embodiment of the invention, a first means for guiding and securing the middle frame and the side frames comprise at least one recess placed in the first and the second side frame in extension of each other, and at least one slide bar placed in the recess of the first and second side frame, by said arrangement the side frames are guided alternately towards and away from each other between the first and the second position.

Thereby, the two side frames move alternately towards each other and apart from each other in a simple, reproducible and stable manner without any backlash.

In a further preferred embodiment of the invention, it comprises two slide bars, the first slide bar being placed in the front area of the upper mould part and the second slide bar being placed in an opposite area of the upper mould part, said second slide bar being axis parallel with the first slide bar.

Thereby, the side frames are led in the right direction and slide as easy as possible.

The bars are placed axis parallel with the moving direction of the side frames.

In a further preferred embodiment of the invention, the upper mould part comprises at least two brackets, said brackets comprising a first end and a second end, said first end being attached to the slide bar and the second end being attached to the middle frame.

In a further preferred embodiment of the invention, the slide bars comprises a hinge being placed in one end of each of the slide bars making a hinged connection to one side frame, said hinge being adapted to be locked by a locking pin, whereby the slide bars are locked to said side frame in a position arranging the slide bars in the mating recess in the oppositely placed side frame.

In a further preferred embodiment of the invention, the upper mould bar further comprises two brackets, each bracket comprising a first end and an oppositely placed second end, said first end comprising a recess fitting and abutting the slide bar, by said arrangement the bracket is slidably connected to the slide bar and the second end is adapted to be attached and fixed to the middle frame.

The slide bars are pivoted down into the recess when the mould is to be assembled. Subsequently, the position is fixed by the locking pin. The locking pin fixates the slide bar in a conventional manner. Subsequently, the middle frame and the slide bars are connected to each other by two brackets. One bracket is connected to one slide bar and to one end of the middle frame and the other bracket is connected to the other slide bar and the other end of the middle frame.

In a further preferred embodiment of the invention, it further comprises use of a mould assembly as described for the inventive apparatus as described.

The invention is explained in detail below with reference to the drawing, in which

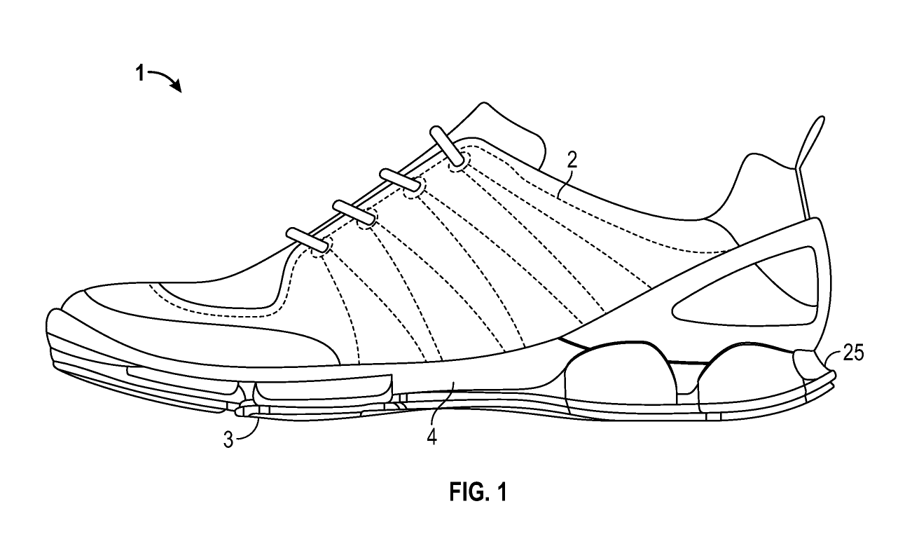

FIG. 1 shows one shoe manufactured according to the invention.

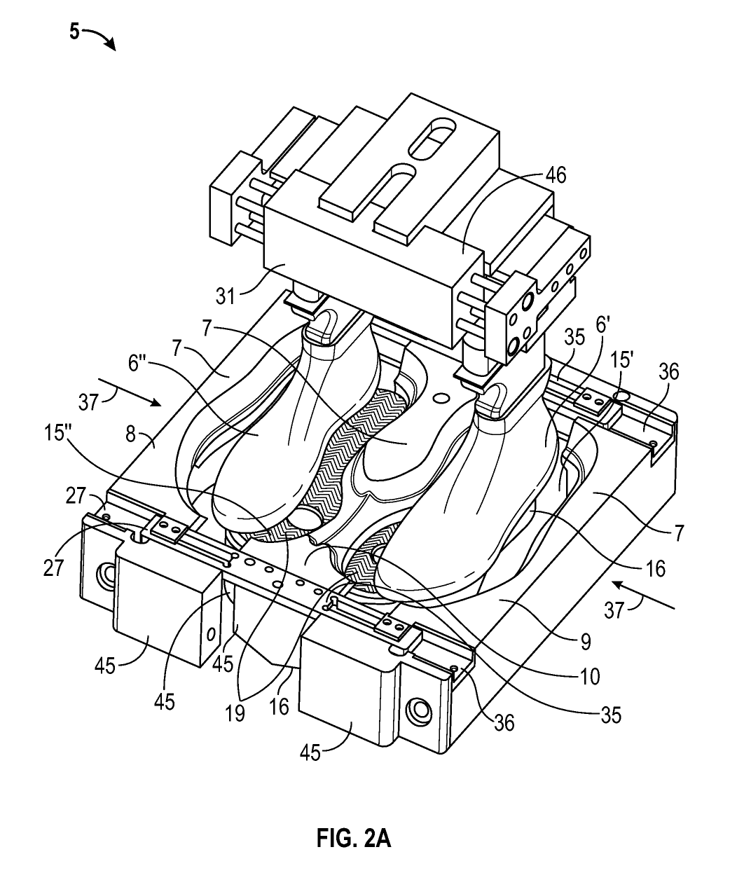

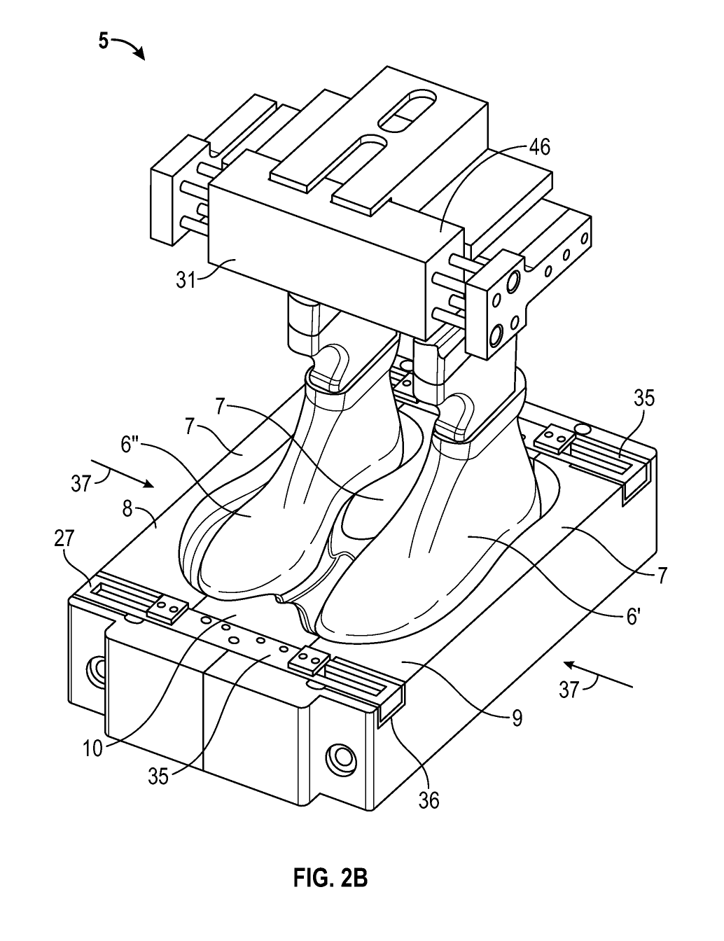

FIG. 2a is a view of a first embodiment of an apparatus according to the invention showing an open mould.

FIG. 2b is another view of the apparatus shown in FIG. 2a showing the mould closed and the lasts placed in the cavities.

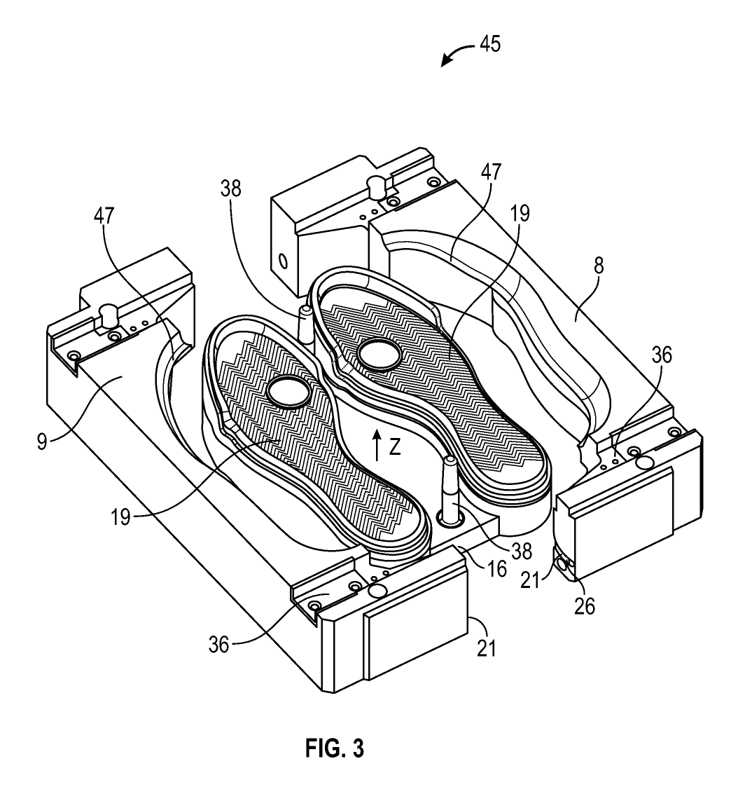

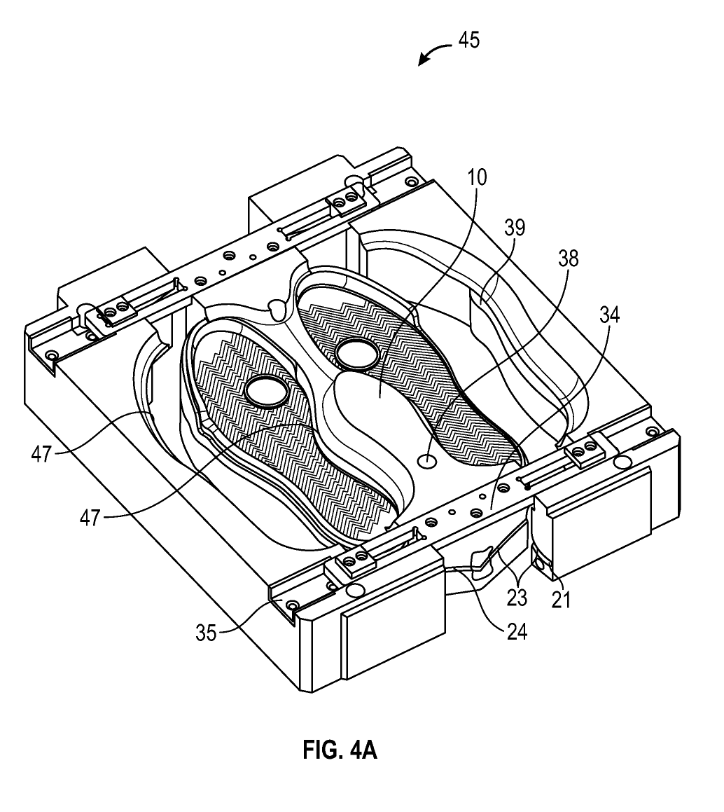

FIG. 3 shows parts of the upper mould and parts of the lower mould shown in FIGS. 2a and 2b and according to the invention.

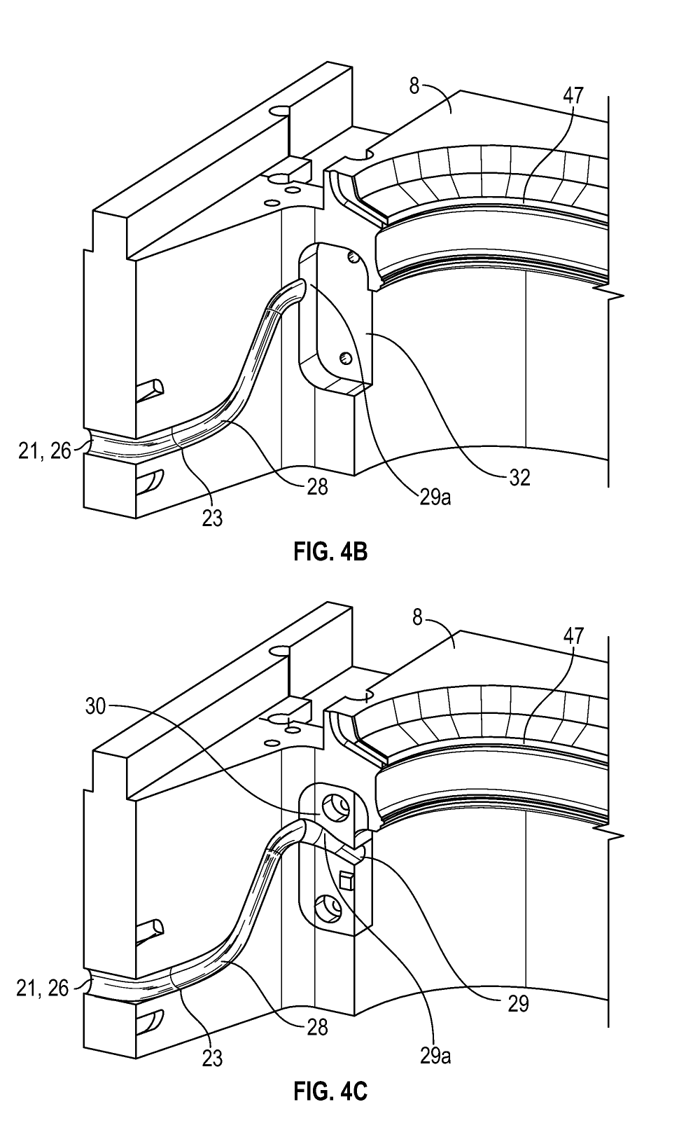

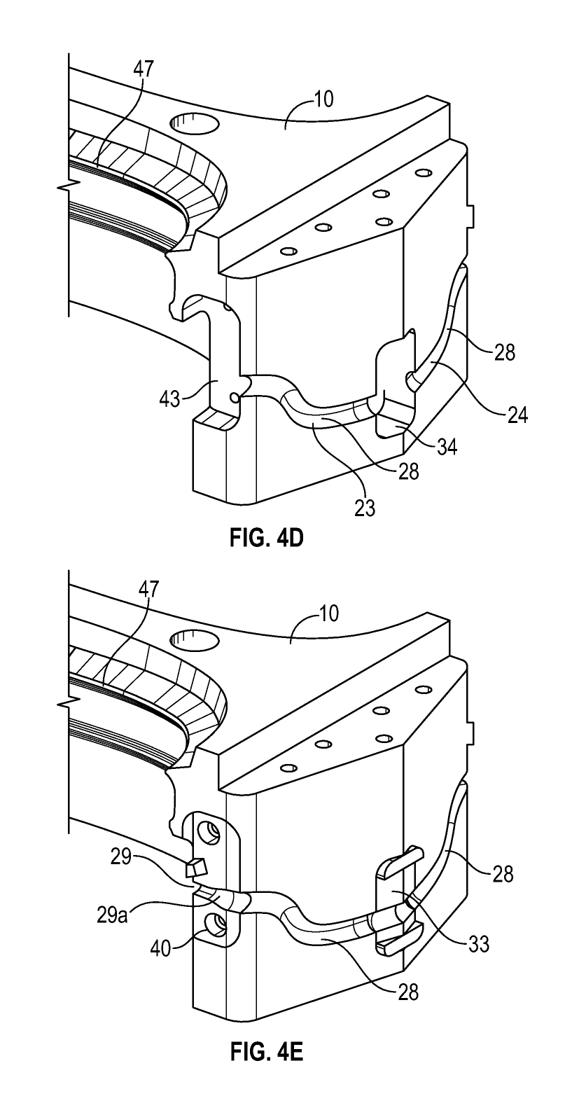

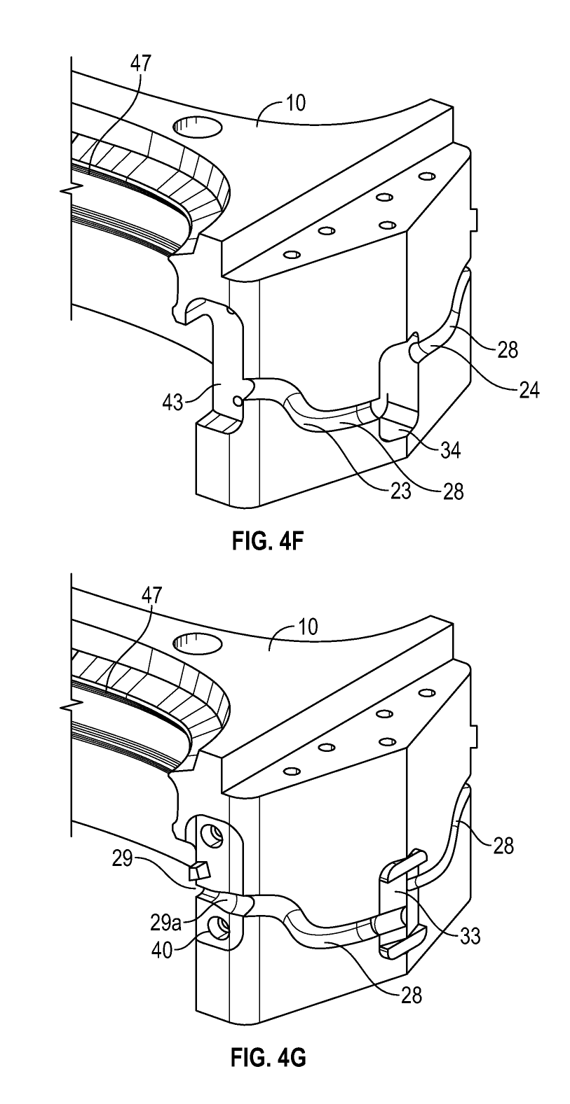

FIG. 4a is another view of the first embodiment and shows the upper mould and parts of the lower mould and the relation between the different mould parts.

FIGS. 4b and 4c are detailed drawings of a channel and outlet construction of the side frames.

FIGS. 4d and 4e are detailed drawings of a channel construction of the middle frame.

FIGS. 4f and 4g are detailed drawings of a second embodiment of a channel construction of the middle frame.

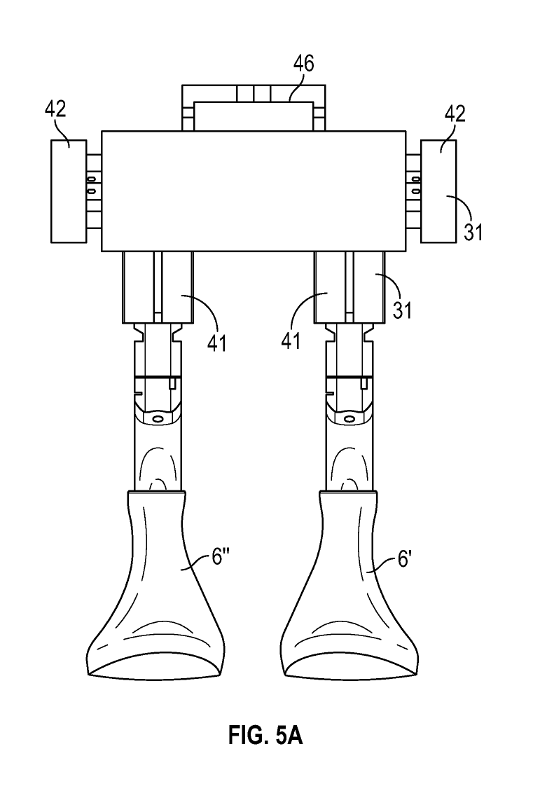

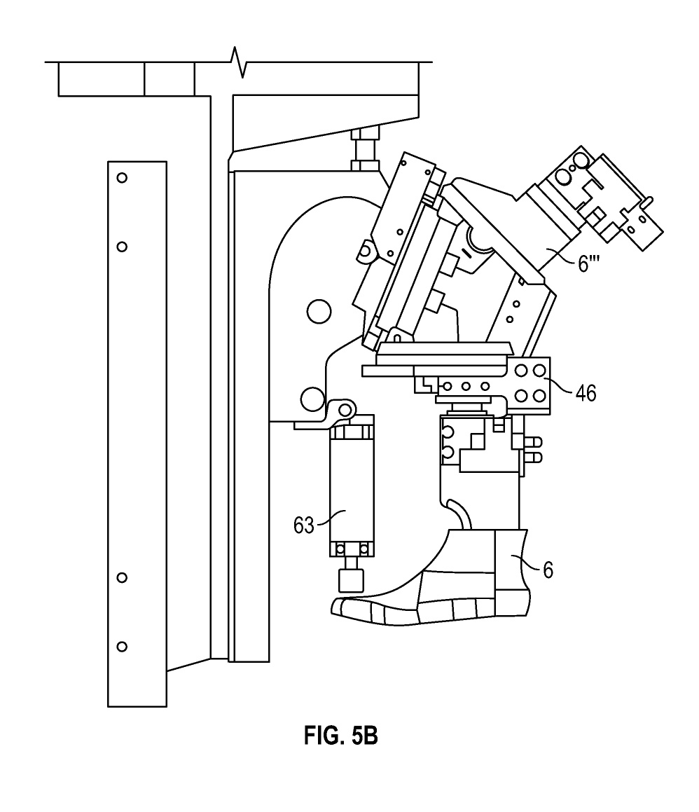

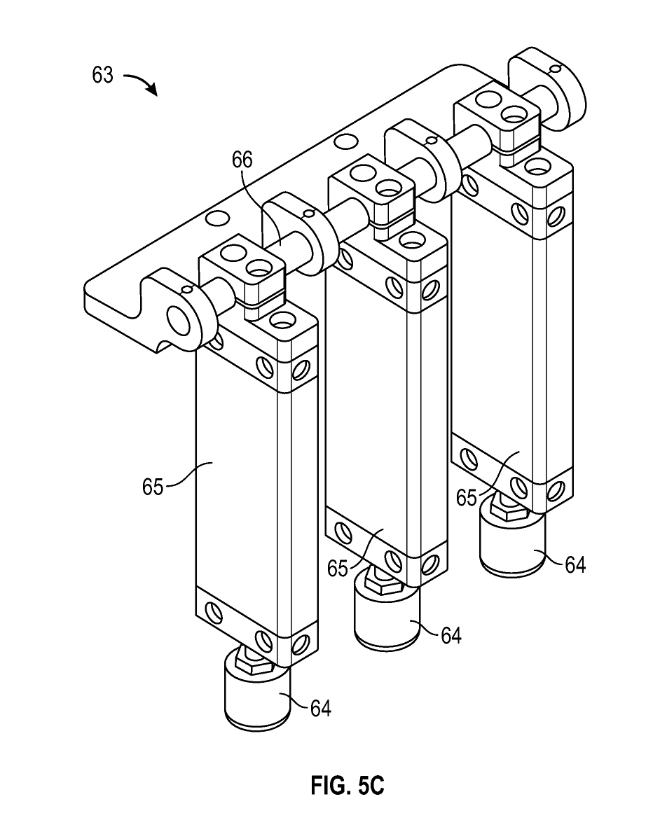

FIG. 5a shows a two-last construction according to the invention.

FIG. 5b shows the last construction including an anti-push-up device

FIG. 5c shows a detailed view of the anti-push-up device shown in FIG. 5b

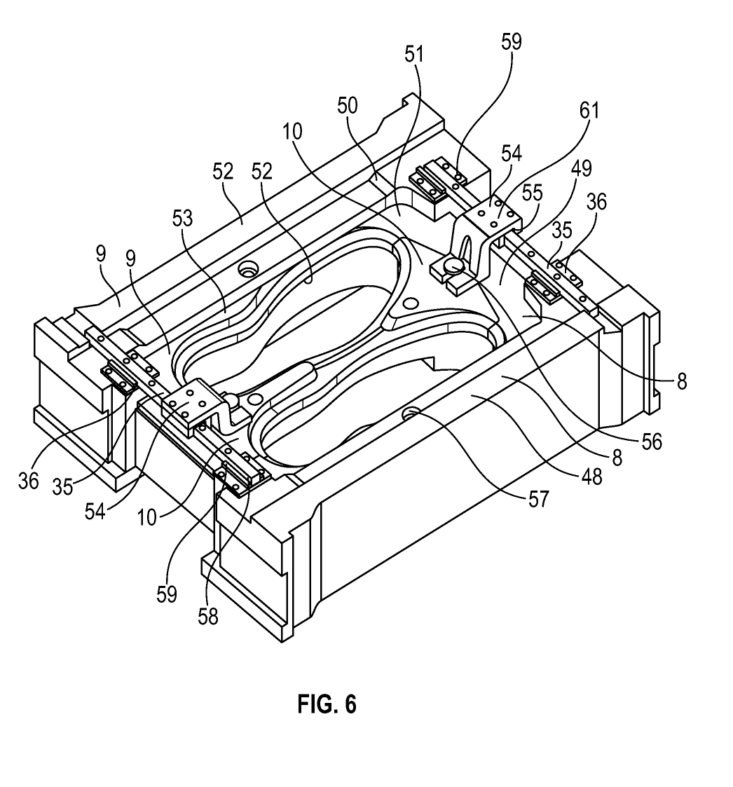

FIG. 6 is a second embodiment of the upper mould in a closed position.

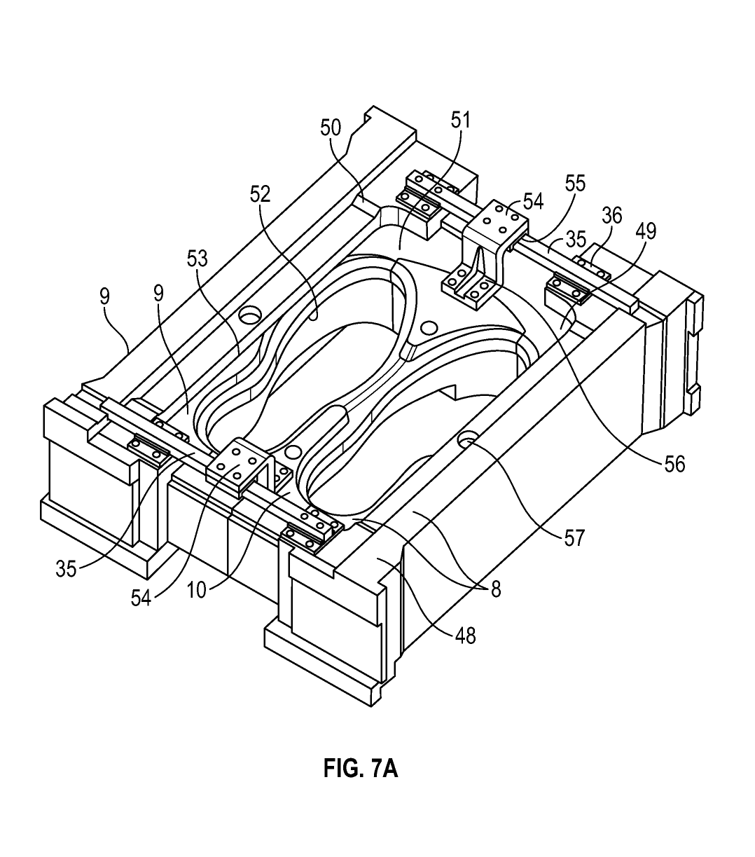

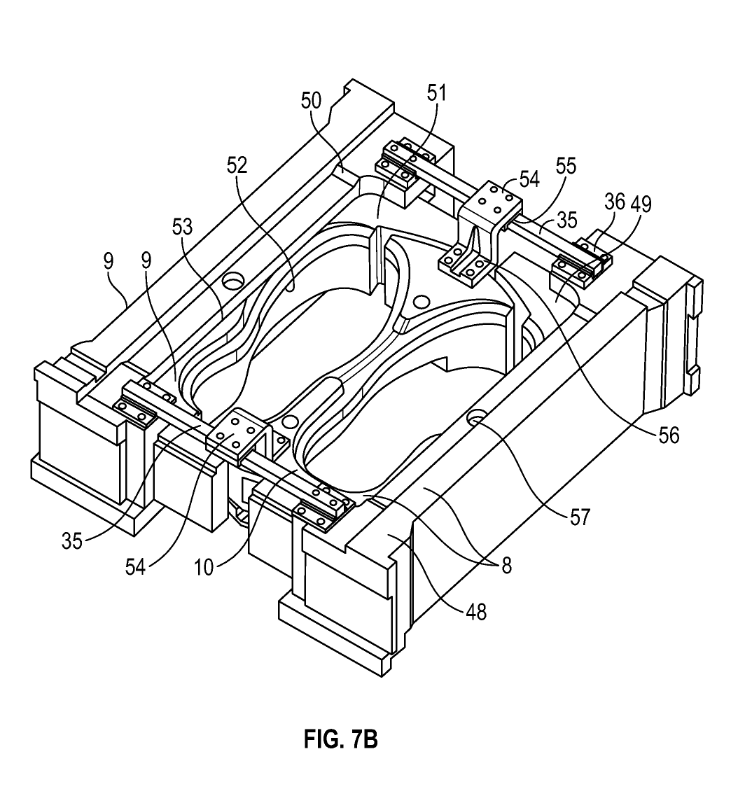

FIG. 7a is a third embodiment of the upper mould in a closed position.

FIG. 7b is another view of the upper mould shown in FIG. 7a.

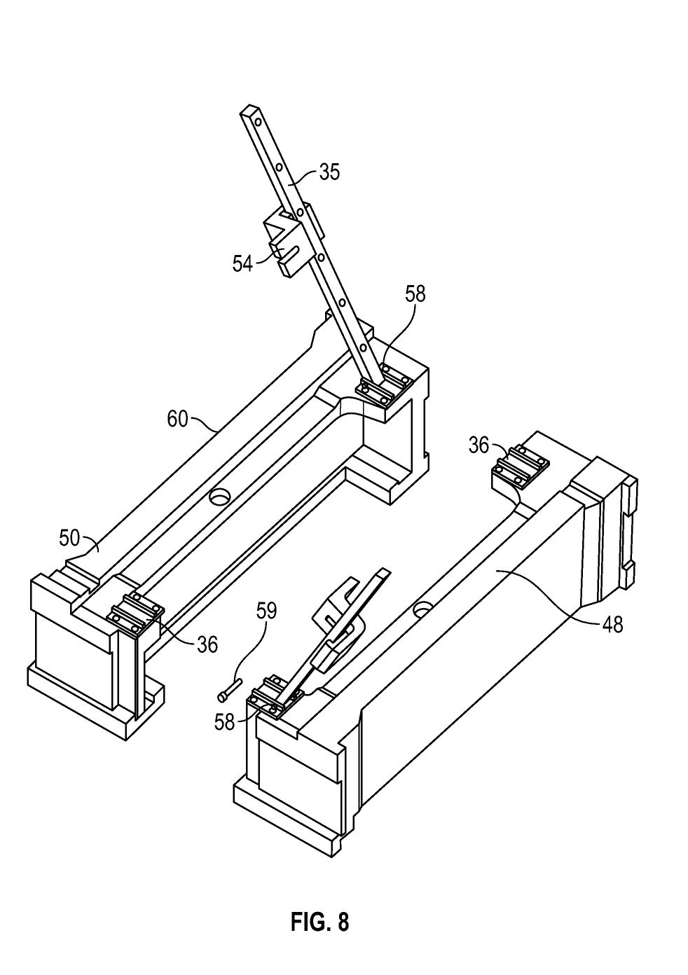

FIG. 8 shows parts of the upper mould.

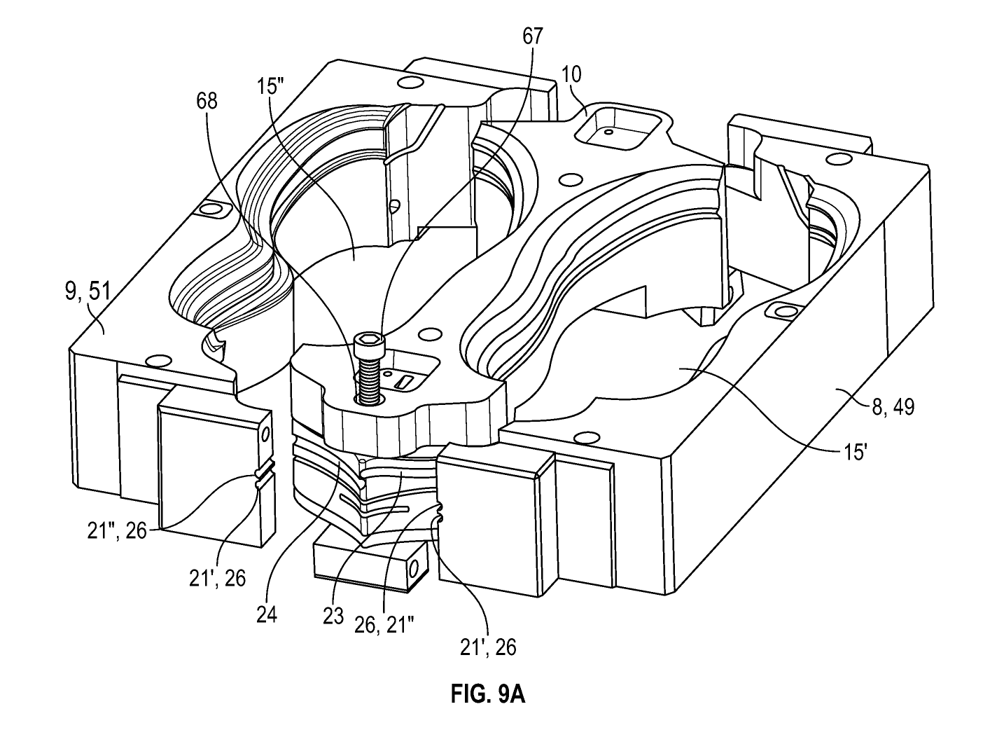

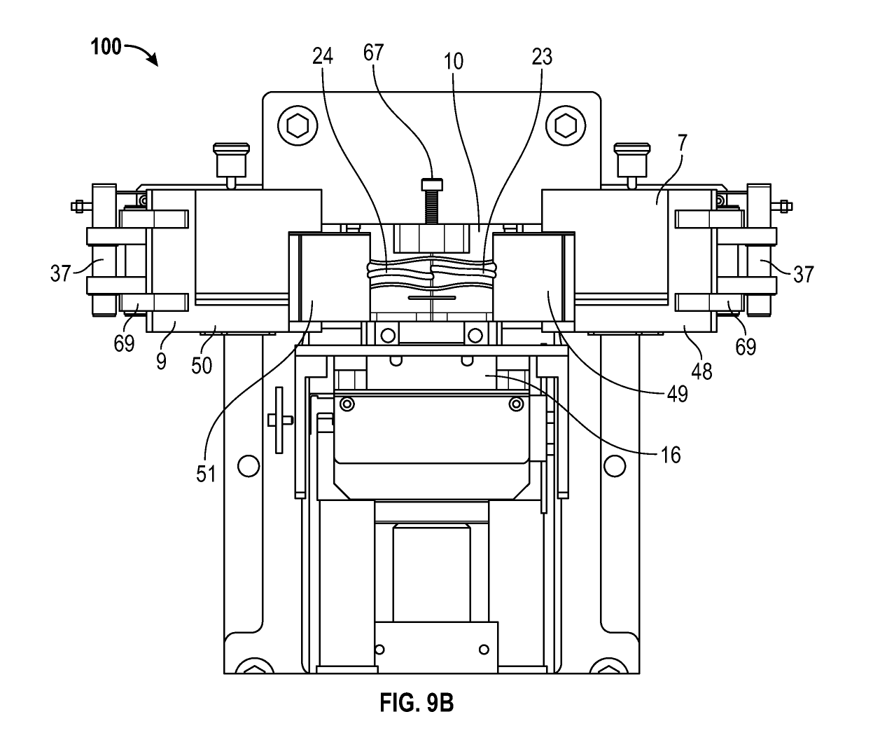

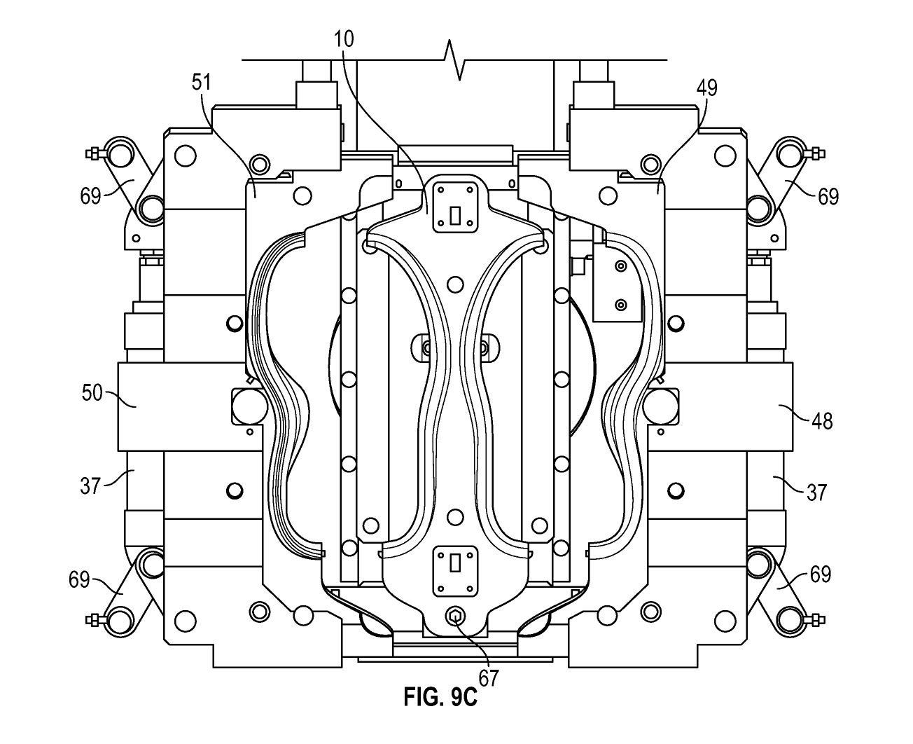

FIG. 9a shows a fourth embodiment of an upper mould.

FIG. 9b shows the embodiment shown in FIG. 9a placed in an apparatus according to the invention.

FIG. 9c is a view of the construction shown in FIG. 9b seen from above.

### DETAILED DESCRIPTION OF THE DRAWINGS

FIG. 1 shows the end product of the present invention: One of the two shoes 1 manufactured with a sole according to the inventive method. In this preferred embodiment, the sole consists of a mid-sole 4, a heel part 25 and an outsole 3, typically a TPU outsole. The soles are placed on an upper 2.

FIGS. 2a and 2b show an apparatus 5 according to the invention comprising a mould assembly 45 and a first last 6′ and a second last 6″ attached to a last aggregate 46. The mould assembly 45 comprises an upper mould part 7 and a lower mould part 16 and two cavities; a first cavity 15′ and a second cavity 15″. The first last 6′ is placed in the first cavity 15′, and the second last 6″ is placed in the second cavity 15″ during the manufacturing process of the shoes 1. The upper mould part 7 comprises two side frames; a first side frame 8 and a second side frame 9 and there-between a middle frame 10. The two side frames 8, 9 are slidably related to each other. By first means 27 they may be slidably connected. In this embodiment, it comprises an arrangement comprising two slide bars 35 and two recesses 36. One recess 36 is placed in the front part of each of the side frames 8, 9 end to end. Another recess is placed in the opposite part of the side frames and in the same way and parallel to the front recess. The two recesses are axis-parallel to each other and perpendicular to the pitch/division surfaces between the two side frames 8, 9. In each of the two recesses 36, the slide bars 35 are placed. By this arrangement, the frames are able to move and slide between a first position, where the mould assembly is open, and a second position, where the mould assembly is closed. The sliding movement takes place as a straight, horizontal and linear movement due to the mounting of the mould in the apparatus.

The first means 27 could also be formed as a mater/pater-arrangement, i.e. several rods/sticks placed at side surfaces of one side frame, the rods/sticks interacting with matching recesses placed at the opposite and abutting surfaces of the other side frame.

The middle frame 10 is immovably but detachably connected to the lower mould part 16. In this way, it is possible to use the same apparatuses for different sizes and designs of shoes. The side frames 8, 9 and the lasts 6′, 6″ are interchangeable as well. When the mould is in its closed position (see FIG. 2b), the upper mould part 8, 9, 10 encloses the two lasts 6′, 6″. The side frames 8, 9 are moved by a closing and moving force 37, such as a piston or a hydraulic arrangement. Due to the sliding movement of the side frames 8, 9, the angle of action of the force is the same all the way through during the movement of the side frames 8, 9. The force is parallel with the direction of movement of the side frames 8, 9.

The closing and moving force operates through a knee-joint. By adjusting the length of stroke, the moving distance of the knee-joint is regulated. Adapters may be arranged between the closing and moving force 37 and surfaces of the side frames. This is relevant if the length of stroke is too short for a chosen mould and the side frames would not reach the middle frame unless the adapters are placed.

The lower mould part 16 comprises two contour plates 19, said contour plates 19 being flexibly and realisably connected to a support surface of the lower mould part 16. See also FIG. 3 and FIG. 4. Due to the flexible connection to the support surface, the contour plates 19 may move relative to the lower mould part 16. The flexibility can be obtained by incorporating means such as springs between the contour plates 19 and the support surface. The contour plates 19 are also acting as part of the mould cavities when the outsoles 3 are manufactured by injection moulding using the apparatus. Another possibility is that the contour plates 19 constitute the support surface for pre-fabricated outsoles placed in the contour plates 19. In case the outer soles 3 are manufactured in the apparatus 5 according to the invention, the upper mould part 7 differs from the upper mould part used when producing the mid-sole 4.

The lower mould part 16 is vertically moveable between a third and a fourth position by means of for example a piston or a hydraulic arrangement. The third position is the start position, and the fourth position is the end position. The end position is when the lower mould part 16 is placed closest to the uppers/the lasts. The two lasts 6′, 6″ are horizontally and vertically moveable by second means 31.

The lower mould part 16 also comprises a second heating element (not shown). The heating element is constructed in such a way that the heating intensity can be regulated. The area where the heating of the lower mould part takes place can also be regulated and changed. The heating intensity—and where it takes place—depends on the material of the composition and the design of the sole, including size and thickness.

FIG. 3 and FIG. 4a show parts of the mould assembly. The lower mould part 16 comprises the two contour plates 19, and between the two contour plates 19, two pater parts 38 are placed. The pater parts 38 are formed as cylindrical rods and perpendicularly placed to the surface to which they are connected. The rods 38 interact with grooves 39, see FIG. 4a, placed in the middle frame 10. The longitudinal axis of the grooves is perpendicular to the surface of the middle frame 10. By this arrangement, the middle frame 10 is stably connected to the lower mould part 16, but is still detachable.

In this embodiment, the side frames 8, 9 comprise one sprue channel 21 for injecting the composition. However, the side frames may also comprise two different vertically displaced sprue channels as explained with reference to FIGS. 4f and 4g. The composition such as ethylene vinyl acetate (EVA), natural or synthetic rubber, polyurethane (PU) or thermoplastic polyurethane (TPU), is led into two spaces defined by the lower surface of the lasts 6′,6″, the contour plates 19, the middle frame 10 and the side frames 8, 9. The sprue channel 21 is formed by the two side frames 8, 9 in a closed position of the side frames, i.e. the two side frames are firmly abutting each other in the front area and in the back area of the frames and enclosing the middle frame. The sprue channel 21 is provided by two semicircle-shaped channels 26 placed in each side frame. When the side frames are in the closed position, the two semicircle-shaped channels 26 are placed opposite each other. They form a closed and substantially circular sprue channel 21. In this way, the inlet of the sprue channel is placed in the centre plane of the mould assembly.

Then, the sprue channel 21 is split into two side channels; a first side channel 23 and a second side channel 24. When the mould is provided with two sprue channels 21, one sprue channel 21 is in fluid connection with the first side channel 23 and the other sprue channel is in fluid connection with the second side channel 24. In this way there is no fluid connection between the two side channels and no risk for back flow of the melt.

The first side channel 23 has at least one outlet positioned in one cavity 15′, and the second side channel 24 has at least one outlet positioned in the other cavity 15″. Both the first and the second side channels are formed by two semi-circular side channels 28, one placed in the side frames, the other placed in the middle frame. When the mould is closed, the two semi-circular side channels abutting 28 each other form a closed channel. The outlet of the first side channel 23 and the second side channel 24 is placed at the heel part 25 of the shoes 1. The upper mould part 7 has projections 47 pointing towards the contour plate area 19, the projections 47 abutting the whole circumference of the uppers, and ensures that the mould is tight when the melt is injected. The projections 47 are placed at the side frames 8, 9 and at the middle frame 10.

FIGS. 4b and 4c show details of the outlet area of one of the side frames 8, 9. The semi-circular channel 26 discharges into the semi-circular side channel 28, the longitudinal axis of the semi-circular side channel 28 being positioned perpendicularly to the longitudinal axis of the semi-circular channel 26. In an outlet area 29a of the side channel 28, the side channel 28 bends approx. 90 degrees towards the position of the contour plate 19. This will induce high abrasion of the side frame in this area. In order to prolong the life time of the side frame, a side frame insert 30 is made in this area. The side frame insert 30 is formed as a substantially rectangular brick fitting into a side frame recess 32. The insert is made in the side frame 8 and is fastened with screws or bolts to the side frame 8. The outlet 29 has a smaller cross-sectional area than the cross sectional area of the side channel in order to provide sufficient pressure when the melt is leaving the channel and is injected into the space for forming the sole.

FIGS. 4d and 4e show details of the middle frame. The surface of the middle frame 10 facing the sprue channel 21 comprises the two semi-circular side channels 28 running in continuation of each other. However, in the area where the sprue channel formed by the side frames is divided into the two side channels 23, 24, the hot melt hits the middle frame 10 exactly where the side channels are parting. A high degree of wear will occur in this area. Therefore, a first middle frame insert 33 is placed in the area. The first middle frame insert 33 is formed as a substantially rectangular brick fitting into a first middle frame recess 34 made in the middle of the surface of the middle frame 10 turning towards the sprue channel 21.

The semi-circular side channel 28 bends substantially 90 degrees in the area of outlet 29a in order to inject the melt into the cavities 15. They follow the semi-circular side channels of the side frames 10. In the area of outlet 29a, a second middle frame insert 40 is placed in a second middle frame recess 43 placed in the middle frame 10. This part is made after the same principles as the side frame insert 30. The side frame insert 30 and the second middle frame insert 40 are aligned with each other by a key/spline arrangement. In this way, the two inserts 30, 40 are always placed in a correct position in relation to each other when the mould is closed. The inserts are all made in steel and are all exchangeable and detachable.

FIGS. 4f and 4g show details of another embodiment of the middle frame. The difference between this embodiment of a mould and the one shown in FIG. 4d and FIG. 4e is the position of the side channels 23, 24 (i.e. the semi-circular channels forming the side channels) in the middle frame. Off course, as a consequence, the same applies for the side frames. In the area of the first middle frame recess 34, the inlets of the side channels are placed. However, the inlet of the first side channel 23 is placed vertically below the second side channel 24. As a consequence of that, the semi-circular parts 28 of the side channels placed in the side frames are off course placed opposite the semi-circular side channels of the middle frame. When the mould is closed the semi-circular channels provide the side channels 23, 34, said inlet of the side channels being displaced vertically in relation to each other. By this construction, a back flow of the melt from one cavity to the other cavity is avoided.

The sprue channel may be constructed as one channel that is divided into a Y shaped channel, each branch connecting the inlet of a side channel. Advantageously, there is two sprue channels, each of them connected to a side channel.

FIG. 5a shows the last aggregate 46 handling the two lasts 6′, 6″. The arrangement comprises the two lasts 6′, 6″ placed parallel and symmetrically around a centre plane of the apparatus 1. The lasts 6′, 6″ are moved by the second means 31 comprising a second part 42 moving the lasts perpendicular to a linear vertical movement. The lasts 6′, 6″ are connected to a suspension by pistons 41 moving the lasts synchronically and vertically, the pistons being part of the second means. The second part comprises a double piston 42 moving the two lasts 6′, 6″ horizontally and straight, but in opposite directions and perpendicular to the vertical movement. Further, the second means 31 may also comprise means for allowing the lasts 6′, 6″ to make small pivotal movements, which may be relevant when adjusting the final placement of the lasts into the mould. The lasts move between a fifth and a sixth position starting from the fifth position and move horizontally towards each other. Then, the lasts move vertically and horizontally to a sixth position, i.e. the final position, where the mould is closed around the lasts in order to start the injection of the composition: Melted polymer.

FIG. 5b shows a side view of a last arrangement comprising the lasts shown in FIG. 5a and where an anti-push-up device 63 is placed in a position before being pressed down. The purpose with the anti-push-up device 63 is to press the tip of the shoe/last down when the moulding process takes place. If there is no pressure at the tip of the shoe, the shoe tip will bend upwards due to the heating. The anti-push-up device 63 is connected and related to the last aggregate 46. In conventional last aggregate systems, the anti-push-up device 63 comprises only one anti-push-up cylinder. In this arrangement, the anti-push-up device 63 comprises 3 anti-push-up cylinders which will be explained with reference to FIG. 5c. The lasts comprise a part of the apparatus.

The last arrangement also comprises a single last 6″. This last is pivoted down and used instead of the double last arrangement when a single cavity mould is used in the apparatus for manufacturing a single shoe.

FIG. 5c shows a detailed drawing of the anti-push-up device 63. It comprises 3 axis parallel anti-push-up cylinders 64 placed side by side. Each anti-push-up cylinder 64 is placed on a profile 65. Each profile is pivotably connected to the same vertically oriented shaft 66. The three anti-push-up cylinders are also vertically displaceable. The middle anti-push-up cylinder 64 is used and vertically moved when the apparatus is used for manufacturing one shoe at a time and as a consequence the mould only comprises one cavity.

The two outermost placed push-up cylinders 64 are used and vertically moved when the apparatus is used for manufacturing two shoes at a time and the mould as a consequence comprises two separate cavities in which two separate lasts are placed.

FIG. 6 is a second embodiment of the upper mould part 7 shown in a closed position. This embodiment could also be used with the apparatus 5 seen in FIGS. 2a and 2b.

The principal difference between this embodiment and the one shown in FIG. 4a is the side frames 8, 9 and the construction of the slide bars 35. Each side frame comprises a slide table 48, 50 and a side mould part 49, 51.

The first side frame 8 comprises a first slide table 48 and a first side mould part 49 and the second side frame 9 comprises a second slide table 50 and a second side mould part 51. The side frames 8, 9 are a mirror image of each other along the plane of symmetry of the assembled upper mould part. Each side mould part 49, 51 comprises a first surface 52 following the contour of the abutting part of the last. This surface 52 turns towards the middle frame 10. An oppositely placed second surface 53 turns away from the middle frame 10. The side mould parts 49, 51 are adapted to be detachably connected to the slide tables 48, 50 by locking means 57, such as a bolt or a screw. The connection must be a stable, tight and immobile connection. The second surface 53 of each of the side mould parts 49, 51 turns towards a surface of the mating slide tables 48, 50. By dividing each of the side frames 8, 9 into two connectable pieces, it is easier to change size and design of the mould as only a part of the side frames 8, 9 are to be exchanged, i.e. the side mould parts. Further, the risk of the upper mould part disclosing leakage is reduced and no melt will leak during the moulding process.

The side frames 8, 9 are connected to each other in a way making the slide towards and away from each other. This is obtained by two slide bars 35 as described above. However, the slide bars are attached to the side frames 8, 9 in the following way, which is disclosed in detail in FIG. 8.

One end of the slide bar is connected to a slide table by a hinge 58. Thereby, the slide bar is pivotally connected to the upper mould part 7. The other end of the slide bar 35 is placed in the recess 36 of the oppositely placed slide table. The slide bar 35 is locked in this position by a locking pin 59, as shown in FIG. 8. The two slide bars 35 are arranged so when the slide bar 35 placed in the front is pivotally connected to the first slide table 48, the other slide bar 35 is placed in the back area and pivotally connected to the second slide table 50. In this way, a stable and secure connection between the two side frames 8, 9 is obtained. The middle frame 10 is also in connection with the slide bars 35 by two brackets 54.

Each bracket 54 comprises a first end 61 and a second end 62. The first end 61 is connected to the slide bar 35 by a bracket recess 55; the bracket recess is slidably placed on the slide bar 35. The second end 62 is detachably attached to the middle frame 10 by a bracket fastener 56, such as a screw or a bolt. By this arrangement, the side frames 8, 9 are slidably related to the middle frame 10. FIG. 7a differs from the embodiment shown in FIG. 6 by the construction of the brackets 54. In this embodiment, the bracket 54 is fastened to the middle frame 10 by several bolts/screws in order to reduce the clearance when the side frames 8, 9 are sliding. FIG. 7a shows the upper mould part in a closed position and FIG. 7b shows the same upper mould part, but in an open position.

FIG. 9a shows a fourth embodiment of an upper mould according to the invention. The references applying to embodiments 1-3 also apply to this embodiment. The principal difference between the embodiment in FIG. 9a and the former embodiments is the fastening of the middle frame 10. The middle frame 10 is immovably fastened to the lower mould part by one end of the middle frame 10 being placed in an undercut in the lower mould part (not shown) and the opposite end of the middle frame 10 being fastened to the lower mould part by a bolt 67 passing through a longitudinal bore 68 in the middle frame and engaging a thread placed in the lower mould part.

The side channels 23, 24 are constructed in the same manner as explained above. However, the inlets of the side channels 23, 24 are vertically displaced in relation to each other. The inlet of the first side channel 23 is placed 1-2 cm above the inlet of the second side channel 24. As a consequence, the mould comprises two separate sprue channels 21′, 21″. One sprue channel is in fluid-tight connection with the first side channel 23 and the other sprue channel 21″ is in fluid-tight connection with the second side channel 24. The mould also comprises the former-mentioned insert (not shown) such as middle frame inserts placed in middle frame recesses when appropriate.

FIG. 9b shows the embodiment shown in FIG. 9a placed in an apparatus 100 according to the invention. It comprises the lower mould part 16 and the upper mould part 7. The upper mould part 7 comprises the first side frame 8 and the second side frame 9. The side frames 8, 9 comprise side mould parts 49, 51. Each side mould part 49, 51 is placed in a slide table 48, 50 as explained above. The slide tables 48, 50 and thereby the side frames 8, 9 are linear and horizontally moved by force means 37 comprising a pneumatic operated piston transferring the forces from said piston through an knee-joint 69 to the side frames 8, 9. Between the side frames 7, 9, the middle frame 10 is placed. At the drawing, the bolt 67 for fastening the middle frame 10 to the lower mould part is partly shown. Between the slide tables and the side mould parts, adapters may be placed in order to adapt the size of the mould to the apparatus.

FIG. 9c shows the relation between the middle frame 10, the first side mould part 49 and the second side mould part 51, the first slide table 48 and the second slide table 50. The side mould parts 49, 51 are connected to the slide tables 48, 50 by fastening means such as a bolt or screws. The pneumatic cylinder/the force means 37 is attached to the knee-joints 69 in both ends of the cylinder. One cylinder is placed on the outer side of each slide table 48, 50 and is connected to the slide table by the knee-joints 69. When a cylinder stroke lengthens the cylinder 37, the knee-joints 69 will be lengthened and the force will be transferred through the knee-joints 69 to the side frames and the mould will be closed. When the cylinder stroke shortens the cylinder 37, the knee-joints 69 will be bent and thereby the side mould parts will be separated and the mould as such will be opened.

By removing the middle frame and exchanging the side mould parts with side mould parts for providing just a single shoe, the apparatus is thus turned into a condition for producing a single shoe at each injection step. At the same time, the programming of the anti-push-up device is changed into using the middle cylinder of the device

The inventive method is performed in the following way: An upper 2 is lasted on each last 6′, 6″, two outsoles are placed on the contour plates, the outsoles being congruent with the shape of the contour plates. However, the outsoles could also be manufactured in a separate process as explained above. The two lasted uppers are lowered into the mould, and both lasts are placed above the contour plate 19′, 19″. The movement of the lasts 6′, 6″ takes place by the second means 31. The two side frames 8, 9 of the mould are moved horizontally towards each other and press against the upper 2. By this movement, the upper of each last 6′, 6″ abuts the side frames 8, 9 and the middle frame 10. Thereafter, a piston moving the lower mould part 16 is elevated and seals the mould. An injection comprising the composition is made through the sprue channel(s) 21. The anti-push-up device is activated and presses the tip of the lasts down. The melt follows the sprue channel(s) 21 and flows further into the two channels 23, 24, i.e. the first side channel 23 and the second side channel 24, and into the two spaces created and delimited by the lower part of the lasts, the side frames, the middle frame and the contour plates. Both channels may have two outlets, one in the area of the heel part 25 and one away from the heel part 25. The lower mould part 16 may move slightly upwards in order to compress the melt. After the injected composition has cured, the two side frames 8, 9 are moved horizontally, straight and away from the lasted uppers 2, said uppers now having a midsole and the outsole bonded to them. The two lasts 6′, 6″ are moved horizontally away from each other in order to release them from undercuts from the middle frame 10. Thereafter, the lasts are raised to their original position, i.e. they are elevated by the pistons 41 in a vertical direction.

The apparatus is suitable for many sizes of moulds. The cavity where the mould is placed may be adjusted in size by placing adapters between the outside surface of the side frames parts/mould parts and the means for pressing the side frames/mould parts towards each other. The adapters are made in a suitable metal and have different size. The surface of an adapter is congruent to the surfaces it abuts.

The middle frame is provided with a first heating element heating the middle frame to a suitable temperature before and during the moulding process.

The lower mould part is provided with a second heating element heating the lower mould part or parts thereof to a suitable temperature before and during the moulding process.

The different embodiment disclosed above differs in principle only in the construction of how the middle frame and the side frames are secured to each other. All the embodiments relates to the same apparatus, the same last aggregate and anti-push-up device, the same construction of the sprue channels (one or two or several), side channels and the same lower mould part. In all the mould embodiments the side channels may have inlets that are vertically displaced in relation to each other or are placed at the same level. Due to the use of adapters and anti-push-up device the apparatus is suitable for a mould with one cavity or with two cavities

The invention is described with one or two sprue channel(s) 21, but there may be several sprue channels, each of them continuing into a side channel and an equal amount of melt is distributed to the two cavities, forming the soles of the footwear.

### LIST OF REFERENCES

1 shoes

2 upper

3 outsole

4 mid-sole

5 apparatus

6 last

7 upper mould part

8 first side frame

9 second side frame

10 middle frame

11 a first position

12 a second position

13 third position

14 fourth position

15 cavities: first cavities 15′, second cavities 15″

16 lower mould part,

17 a composition

18 a space

19 two contour plates

20 flexible means

21 sprue channel

22

23 first side channel

24 second side channel

25 the heel parts

26 semi-circular channel

27 first means

28 semi-circular side channel

29 outlet side channel

30 side frame insert

31 second means

32 side frame recess

33 first middle frame insert

34 first middle frame recess

35 slide bar

36 recess

37 closing and moving force

38 rod/stick)

39 groove

40 second middle frame insert

41 piston moving lasts vertical

42 double piston

43 second middle frame recess

45 mould assembly

46 last aggregate

47 projections

48 first slide table

49 first side mould part

50 second slide table

51 second side mould part

52 first surface of the side mould part

53 second surface of the side mould part

54 bracket

55 bracket recess

56 bracket fastener

57 attachment means (locking means)

58 hinge

59 locking pin

60 first wall of slide tables

61 bracket first end

62 bracket second end

63 anti-push-up device

64 anti-push-up cylinder

65 aggregate/profile

66 shaft

First heating element (middle frame 9)

Second heating element (lower mould part)

67 bolt

68 bore

69 knee-joint

100 apparatus

1. A mould assembly for moulding two soles for two shoes (1) simultaneously such as midsoles and outsoles, said mould assembly (45) comprising an upper mould part and a lower mould part (16), said upper mould part comprising three parts, a first side frame (8) and a second side frame (9) and between them a middle frame (10), said first (8) and second (9) side frame adapted to be laterally movable in relation to the middle frame (10) and in relation to the lower mould part (16); said mould assembly comprising two cavities (15′,15″) for forming the soles, said mould assembly (45) comprising force means (37) adapted to move the two side frames (8, 9) in a straight and linear movement towards the middle frame (10), said lower mould part (16) is adapted to being vertically movable in relation to the upper mould part by moving means.

2. A mould assembly according to claim 1, wherein the force means (37) comprises means such as a piston for opening and closing the upper mould part, said force means (37) placed in relation to the first and second side frame (8, 9) and adapted to move the side frames linear and straight opposite each other.

3. A mould assembly according to claim 1 wherein the lower mould part (16) comprises two contour plates (19) enclosed by the upper mould part, said contour plate (19) having a contour similar to the outsole of the footwear and the contour plates (19) being connected to the lower mould (16) part by flexible means connecting the contour plates (19) to the lower mould part, by said flexibility the contour plates (19) are adapted to move relative to the lower mould part.

4. A mould assembly according to claim 1 wherein the upper mould part comprises at least one sprue channel (21), the sprue channel being provided by two half cup-shaped channels (26) placed in each of their side frames (8, 9), the two cup-shaped channels (26) forming the sprue channel (21) when the two side frames (8, 9) are in the closed position abutting each other.

5. A mould assembly according to claim 1 wherein the upper mould part comprises two sprue channels (21), each sprue channel (21) being provided by two channels shaped as half cup channels (26), said half cup channels (26) being placed in each their side frames (8, 9), the two oppositely placed cup-shaped channels forming one sprue channel (21) when the two side frames are in the closed position abutting each other.

6. A mould assembly according to claim 5 wherein each sprue channel(s) (21) is/are continuing into side channels: a first side channel (23) placed with at least one outlet at the first cavity and a second side channel (24) placed with at least one outlet at the second cavity.

7. A mould assembly according to claim 1 wherein the mould assembly comprises two separate and vertically displaced sprue channels (21), one sprue channel continuing into a first side channel (23) and the other sprue channel continuing into a second side channel (24) and the inlets of the side channels being vertically displaced in relation to each other and each inlet being in fluid-tight connection with a sprue channel (21) when the mould is in its closed position.

8. A mould assembly according to claim 1 wherein the upper mould part comprises an insert (33) detachably placed in a recess of the middle frame and in the area where the sprue channel (21) continues into the side channels.

9. A mould assembly according to claim 1 wherein the upper mould part further comprises an insert (30) detachably placed in a recess in each of the side frames and in an area where the first and the second side channels are bending towards the cavities.

10. A mould assembly according to claim 1 wherein the upper mould part further comprises two inserts, each detachably placed in a recess and each placed at the outlet of the side channels, the first insert (30) being placed in the side frame, and the second insert (40) being placed in the middle frame, said two inserts being aligned with each other by a key arrangement when the mould is closed.

11. A mould assembly according to claim 1 wherein the first side frame (8) comprises a first slide table (48) and a first side mould part (49), and the second side frame (9) comprises a second slide table (50) and a second side mould part (51), said each side mould part comprising a first surface following the contour of the abutting part of the last (6), said surface turning towards the middle frame (10) and an oppositely placed second surface turning away from the middle frame (10), said side mould parts (49, 51) being adapted to be detachably connected to the slide tables (48, 50) by connecting means, and said second surface of the side mould parts turning towards a surface of each of the slide tables.

12. A mould assembly according to claim 1 wherein the middle frame (10) is heated by a first heating element integrated in or abutting the middle frame, by said heating the temperature of the middle frame reaches a suitable value for the process.

13. A mould assembly according to claim 1 wherein the lower mould part (16) is heated by a second heating element integrated in or abutting the lower mould part.

14. Apparatus for manufacturing of footwear comprising a mould assembly for forming one or simultaneously two shoes (1), said apparatus comprising a lower mould part (16) and a upper mould part comprising side frames, said lower mould part (16) comprising a first cavity (15′) and a second cavity (15″) or one single cavity, said side frames comprising a first side frame (8) and a second side frame (9), said side frames being placed at each side of the centre plane of the apparatus, said apparatus comprising force means (37) for moving the side frames (8, 9) towards and away from each other, between a first and a second position, said apparatus further comprising at least one exchangeable last (6) moved by means of second means (31), said last(s) is/are adapted to be placed in the cavity/each cavity when the side frames (8, 9) are in their second position, wherein the force means (37) are adapted to position the first and the second side frame (8, 9) when the side frames are in the second position being the closed position of the mould, said apparatus further comprising a separate anti-push-up device comprising at least two anti-push-up cylinders, said anti-push-up cylinders being arranged in order to prevent a movement upwards of the tip of the last(s) during moulding of the shoe/sole, said cylinders being adapted to be activated such that two cylinders are moving synchronically when two shoes are formed and one cylinder is activated when one shoe is formed.

15. Apparatus according to claim 14, wherein the apparatus comprises three separate anti-push-up cylinders (64), said anti-push-up cylinders (64) being arranged in order to prevent a movement upwards of the tip of the lasts during moulding of the shoe/sole, said cylinders (64) being arranged in line and adapted to be activated such that the outer two of the cylinders are moving synchronically while the middle cylinder is stationary or is moving alone while the two outer cylinders are stationary.

16. Apparatus according to claim 14 wherein the first side frame (8) comprises a first slide table (48) and a first side mould part (49), and the second side frame (9) comprises a second slide table (50) and a second side mould part (51), said each side mould part (49, 51) comprising a first surface (52) following the contour of the abutting part of the last, said surface turning towards the middle of the apparatus and an oppositely placed second surface (53), said side mould parts (49, 51) being adapted to be detachably connected to the slide tables (48, 50) by locking means (57), said second surface (53) of the side mould parts turning towards a surface of each of the slide tables (48, 50).

17. Apparatus according to claim 14 wherein the mould assembly (45) further comprises an exchangeable middle frame, said middle frame being locked by means unmovable to the lower mould part (16) and placed between the side frames, whereby two cavities are made, said apparatus further comprising two lasts; a first last and a second last, said first last adapted to be placed in the first cavity and the second last adapted to be placed in the second cavity.

18. Apparatus according to claim 17, wherein the middle frame (10) is exchangeably and immovable connected to the lower mould (16) part by means of e.g. a screw and/or an undercut.

19. Apparatus according to claim 14 wherein the second means (31) are adapted to move the lasts (6) in a horizontal and vertical direction and comprising parts such as a piston, each step of movement being linear.

20. Apparatus according to claim 14 wherein the second means (31) comprise a second part such as a double piston (42) moving the lasts simultaneously in a direction perpendicular to the linear vertical movements, said first last being adapted to be moved in the opposite direction of the movement of the second last.

21. Apparatus according to claims 14 20, claim 14 wherein the lower mould part (16) comprises two contour plates (19) enclosed by the upper mould part (7), said each contour (19) plate having a contour similar to the outsole of the footwear, and the contour plates being connected to the lower mould part (16) by flexible means connecting the contour plates to the lower mould part (16), the contour plates (19) being adapted by said flexibility to move relative to the lower mould part (16).

22. Apparatus according to claim 14 wherein a first heating element is placed in or abuts the middle frame (10).

23. Apparatus according to claim 14 wherein a second heating element is placed or abuts the lower mould part.

24. Apparatus according to claim 14 wherein the apparatus further comprises an adapter, said adapter being constructed to be placed in relation to the side frames.

25. (canceled)
